(19) United States
(12) Patent Application Publication
(10) Pub. No.: US 2015/0216009 A1
(43) Pub. Date: Jul. 30, 2015

(54) Control Methods and Backlight Controllers for Light Dimming

(71) Applicant: Leadtrend Technology Corporation, Hsinchu (TW)

(72) Inventors: Ching-Tsan Lee, Hsinchu (TW); Mao-Shih Li, Hsinchu (TW)

(21) Appl. No.: 14/597,567

(22) Filed: Jan. 15, 2015

(30) Foreign Application Priority Data
Jan. 27, 2014 (TW) 103102845

(51) Int. Cl. H05B 33/08; H05B 37/02

(52) U.S. Cl. CPC H05B 33/0845; H05B 37/0281; H05B 33/083

(57) ABSTRACT

A control method is disclosed for light dimming. A dimming condition signal is provided to represent whether a light emitting device is expected to be emitting light. The duration when the dimming condition signal is at a logic value indicating the light emitting device is emitting light is a dimming-ON time, in which a close loop is provided to make a power converter convert electric energy to the light emitting device such that the light emitting device is capable of emitting light. A power-ON time is the duration when the power converter converts electric energy to the light emitting device. When the dimming-ON time ends and is less than a minimum power-ON time, the power converter continues converting the electric energy to the light emitting device so as to keep the power-ON time not less than the minimum power-ON time.

### CROSS-REFERENCE TO RELATED APPLICATION

This application claims priority to and the benefit of Taiwan Application Series Number 103102845 filed on Jan. 27, 2014, which is incorporated by reference in its entirety.

### BACKGROUND

The present disclosure relates generally to control methods and apparatuses for light dimming, and more specifically to backlight controllers and dimming control methods capable of avoiding flickering.

As superior in power-to-light conversion efficiency, product size and device lifespan, light emitting diodes (LEDs) have long being utilized in applications of lighting and backlights. For example, nowadays, the backlight modules, which were used to employ cold cathode fluorescent lamps (CCFLs) as light sources, are commonly employing LED modules.

Circuitry for driving LEDs in a backlight module normally has two stages. The first one is a power converter, which could be a switching mode power supply, for converting and providing electric energy to the LEDs so they could emits light. The second stage is a constant current controller for regulating the amplitude of the current through the LEDs.

Dimming is a common function required for a LED module, as the brightness of a backlight frequently needs adjustment. It is well known in the art that dimming methods are categorized into two ways. One is called PWM dimming or digital dimming, the other analog dimming. PWM dimming uses a digital dimming signal that determines a duty cycle of a LED, or the ratio of the time duration when the LED emits light to the cycle time of the digital dimming signal. Normally, for PWM dimming, when an LED emits light, its light intensity is a constant irrelevant to the duty cycle. Analog dimming uses an analog dimming signal instead to regulate the amplitude of the current flowing through a LED, so it emits light constantly and continuously and its brightness is determined by the analog dimming signal.

A power converter for driving a LED usually utilizes a close loop to regulate an output voltage. This close loop certainly has it limited bandwidth and response time. If the close loop is activated for a duration less than its response time, the power converter, as not having enough time to stabilize the close loop, might provide power energy not as sufficient as that for driving the LED properly. Probably, human eyes might conceive that the LED becomes dark for a while every certain period of time. This phenomenon, also called flickering in the art, is very unpleasant to human eyes and should be avoided.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 demonstrates a backlight module in the art;

FIG. 2A shows some waveforms of signals in FIG. 1;

FIG. 2B shows some waveforms of signals in FIG. 1 when dimming-ON time T_{DIM-ON} becomes very short;

FIG. 3 demonstrates a backlight module according to embodiments of the invention;

FIG. 4 details the backlight module in FIG. 3;

FIG. 5A shows some waveforms of signals in FIG. 4 when dimming-ON time T_{DIM-ON} is less than a predetermined minimum power-ON time T_{MIN-ON};

FIG. 5B shows some waveforms of signals in FIG. 4 when dimming-ON time T_{DIM-ON} exceeds minimum power-ON time T_{MIN-ON}; and

FIGS. 6 and 7 show two flow charts for generating power-ON signal S_{POWER}, hold signal S_{HOLD}, and selection signal S_{SEL}, both suitable for the use in a state controller.

### DETAILED DESCRIPTION

In order to prevent flickering, one embodiment of the invention defines a minimum power-ON time, which is the minimum period of time when a power converter continues transferring or providing electric power. In some conditions, the power converter is not allowed to stop providing electric power to a LED module until the end of the minimum power-ON time. In an embodiment, when a LED module stops emitting light, the close loop regulating the electric power that the power converter converts is made open immediately, but the power converter continues transferring electric power until the end of the minimum power-ON time.

Accordingly, in the condition when the digital dimming signal for PWM dimming has a quite short ON time, the power converter will transfer over sufficient power to the LED module and build a sufficient output voltage, so the LED module is capable of emitting light with desired amplitude in subsequent dimming-ON times.

The close loop could be made open for several cycle times of the digital dimming signal. The output voltage, as the close loop no more regulates it, might go over high and triggers the occurrence of an over voltage event. In one embodiment of the invention, once the over voltage event occurs, the power converter is stopped from converting power but the PWM dimming continues.

In one embodiment, a power converter might not be necessary to continue transferring power until the end of the minimum power-ON time. During the time when a LED module emits light, if the output voltage driving the LED module is considered to be too low, or lower than a predetermined safe level, then the power converter is forced to continue transferring electric power until the end of the minimum power-ON time. Otherwise, if the output voltage driving the LED module is considered to be sufficient, or higher than a certain level, then the power converter stops transferring power simultaneously at the time when the LED stops emitting light.

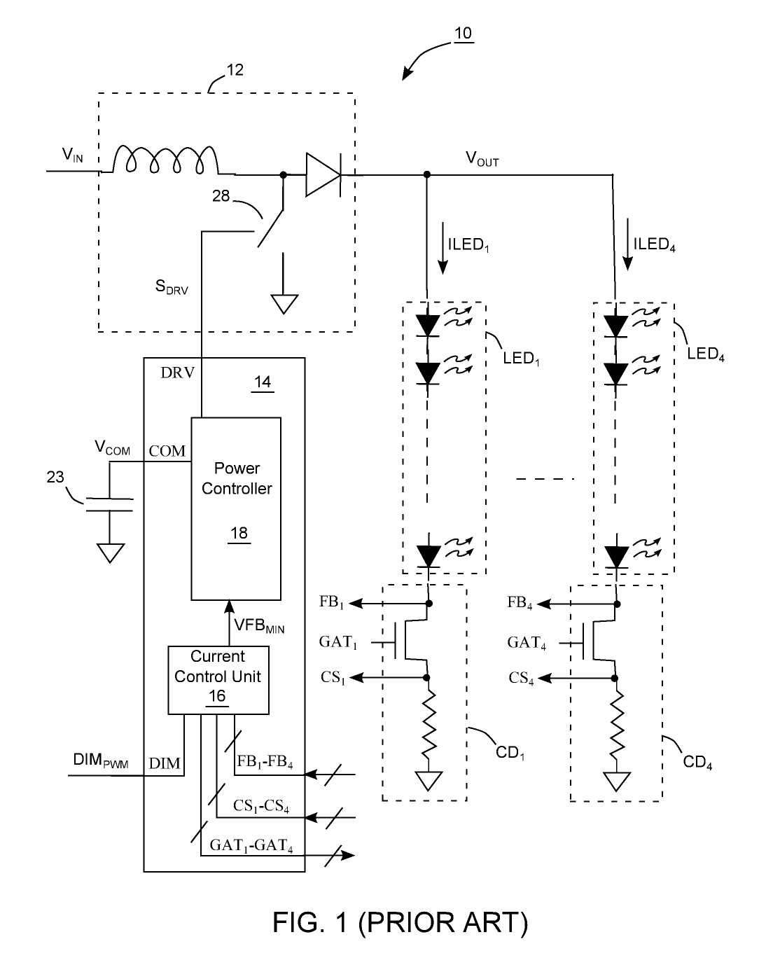

FIG. 1 demonstrates a backlight module 10 in the art, which has four LED modules LED₁˜LED₄ as an example, each LED module comprising LEDs connected in series. Each LED module preferably has, but is not limited to have, the same number of LEDs. A boost converter 12, as an example of a power converter, transfers electric power from input voltage V_{IN} to build output voltage V_{OUT}, which powers LED modules LED₁˜LED₄. Driving currents ILED₁˜ILED₄ go through LED modules LED₁˜LED₄, and are controlled by current drivers CD₁˜CD₄ respectively.

Backlight module 10 utilizes PWM dimming, and receives digital dimming signal DIM_{PWM} to control the brightness of LED modules LED₁˜LED₄. Backlight controller 14 includes a power controller 18 in control of boost converter 12, and a current control unit 16 in control of current drivers CD₁˜CD₄. Based on digital dimming signal DIM_{PWM}, power controller 18 decides whether booster converter 12 is enabled to convert electric power, and current control unit 16 determines the values of driving currents ILED₁˜ILED₄. Taking LED module LED₁ for example, if backlight controller 14 expects to turn it ON, driving currents ILED₁ is controlled to be a positive constant independent to the compensation voltage V_{COM}. Nevertheless, if backlight controller 14 expects to turn it OFF, then driving current ILED₁ is to be about OA. Current control unit 16 forwards to power controller 18 a minimum feedback voltage VFB_{MIN}, which corresponds to the minimum of voltages at terminals FB₁˜FB₄.

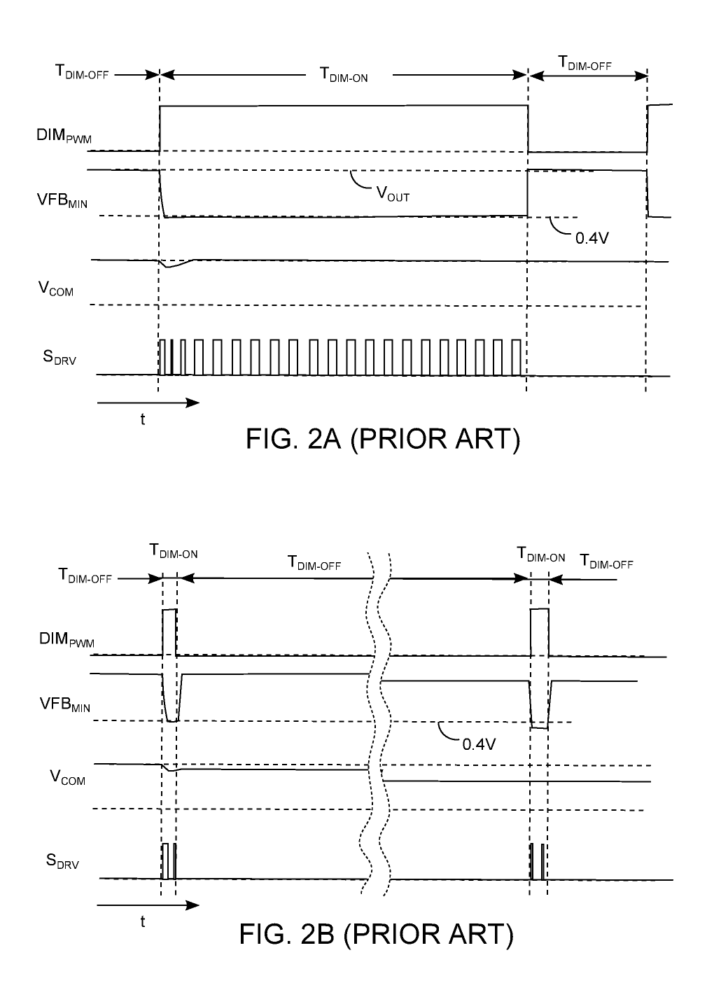

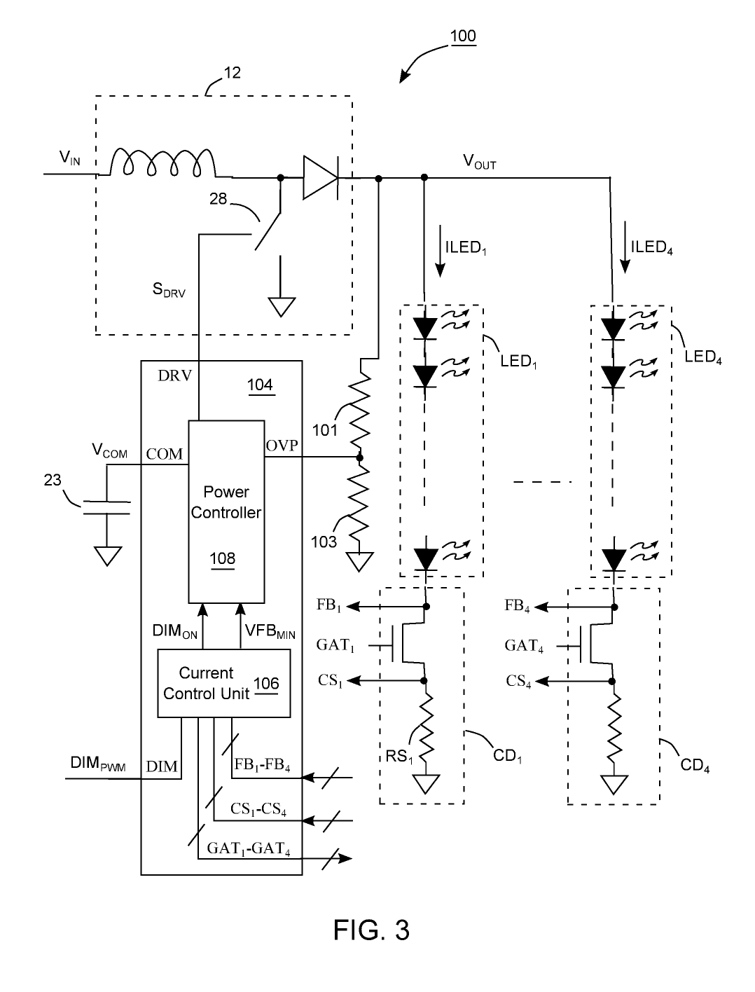

FIG. 2A shows some waveforms of signals in FIG. 1, comprising from top to bottom, digital dimming signal DIM_{PWM}, minimum feedback voltage VFB_{MIN}, compensation voltage V_{COM} at pin COM, and control signal S_{DRV} that power controller 18 sends to drive power switch 28. In FIG. 2A, when digital dimming signal DIM_{PWM} is held as “1”, LED modules LED₁˜LED₄ emit light, and in the opposite, when digital dimming signal DIM_{PWM} is held as “0”, LED modules LED₁˜LED₄ stop emitting light. Even though dimming-ON time T_{DIM-ON} in FIG. 2A refers to the duration when digital dimming signal DIM_{PWM} is “1”, and dimming-OFF time T_{DIM-OFF} to the duration when it is “0”, it is not necessary to. In this specification, nevertheless, dimming-ON time T_{DIM-ON} refers to the duration when at least one of the LED modules is turned ON to emit light, and dimming-OFF time T_{DIM-OFF} to the duration when all LED modules are turned OFF.

As shown in FIG. 2A, during dimming-OFF time T_{DIM-OFF}, control signal S_{DRV} is fixed as “0” such that power switch 28 is turned OFF, and boost converter 12 stops converting electric energy. During dimming-OFF time T_{DIM-OFF}, LED modules LED₁˜LED₄ all are turned OFF, driving currents ILED₁˜ILED₄ all are about 0 A, so minimum feedback voltage VFB_{MIN} is about the same as output voltage V_{OUT}. Please note the compensation voltage V_{COM} held as unchanged during dimming-OFF time T_{DIM-OFF}

Shown in FIG. 2A, control signal S_{DRV} has pulses during dimming-ON time T_{DIM-ON} to switch power switch 28 periodically such that boost converter 12 converts electric power to build up output power V_{OUT}, which powers LED modules LED₁˜LED₄ to emit light. Since there is at least one LED module turned ON to emit light during dimming-ON time T_{DIM-ON}, minimum feedback voltage VFB_{MIN} drops and remains at a target level, which for example is 0.4V in FIG. 2A. For instance, during dimming-ON time T_{DIM-ON}, the difference between minimum feedback voltage VFB_{MIN} and 0.4V is used to adjust compensation voltage V_{COM}, which determines the pulse width of a present pulse in control signal S_{DRV}. Therefore, the signal path from minimum feedback voltage VFB_{MIN}, to compensation voltage V_{COM}, control signal S_{DRV}, and output voltage V_{OUT}, and back to minimum feedback voltage VFB_{MIN} forms a close loop with a negative loop gain. Based on this close loop, compensation voltage V_{COM} is expected to stay stably at a steady voltage, the pulse widths of the pulses of control signal S_{DRV} are modulated, and minimum feedback voltage VFB_{MIN} is regulated to be about 0.4V.

FIG. 2B shows some waveforms of signals in FIG. 1 when dimming-ON time T_{DIM-ON} becomes very short. Once dimming-ON time T_{DIM-ON} becomes too short, compensation voltage V_{COM} might not reach its steady voltage before the end of dimming-ON time T_{DIM-ON}. Therefore, compensation voltage V_{COM} at the time when the dimming-ON time T_{DIM-ON} ends differs with itself at the time when the dimming-ON time T_{DIM-ON} starts. As shown in the left portion of FIG. 2B, compensation voltage V_{COM} drops a little bit after experiencing one dimming-ON time T_{DIM-ON}, and compensation voltage V_{COM} decreases over time as long as the switching cycle of the digital dimming signal DIM_{PWM} increases. The decrement of compensation voltage V_{COM} implies boost converter 12 reduces the power it converts. Eventually, boost converter 12 might not convert enough power to let LED modules LED₁˜LED₄ emit light during a subsequent dimming-ON time T_{DIM-ON}. As shown in the right portion of FIG. 2B, during a dimming-ON time T_{DIM-ON}, minimum feedback voltage VFB_{MIN} is significantly below the target level, 0.4V, and one of LED modules LED₁˜LED₄ that are expected to emit light during dimming-ON time T_{DIM-ON} might not emit light as a result.

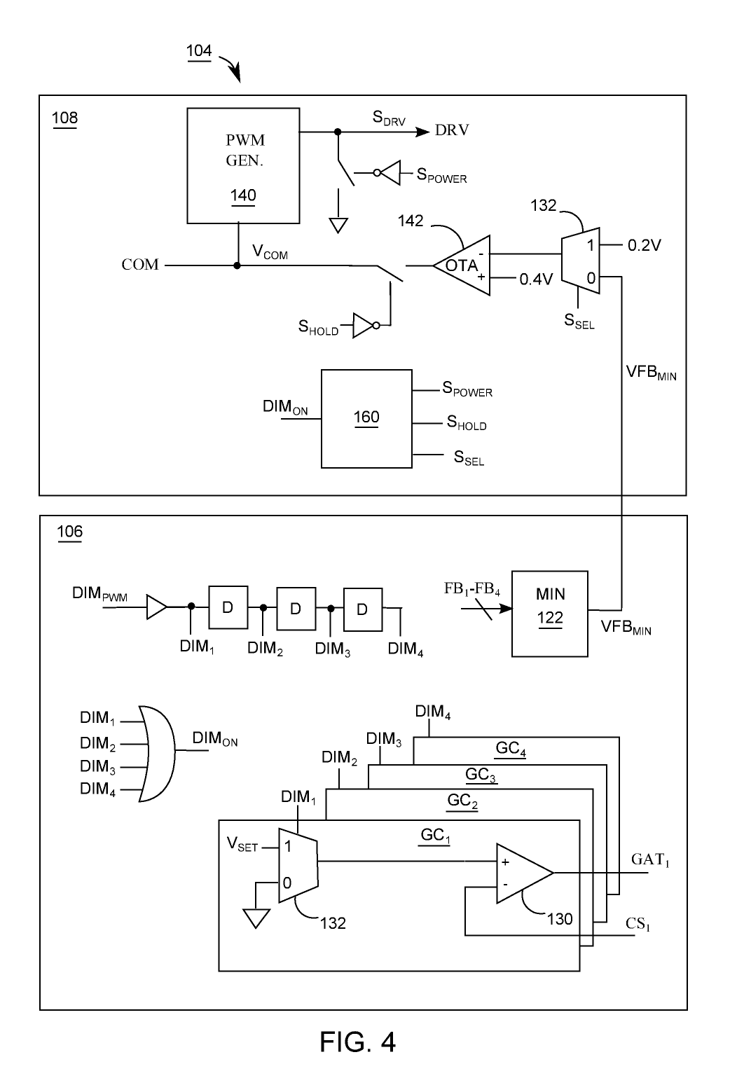

FIG. 3 demonstrates a backlight module 100 according to embodiments of the invention. In FIG. 3, the backlight controller 104 could be a packaged integrated circuit with pins DRV, COM, DIM, FB₁˜FB₄, CS₁˜CS₄, GAT₁˜GAT₄ and OVP. Connected to backlight controller 104 are boost converter 12, compensation capacitor 23, LED modules LED₁˜LED₄, current drivers CD₁˜CD₄, voltage-dividing resistors 101 and 103.

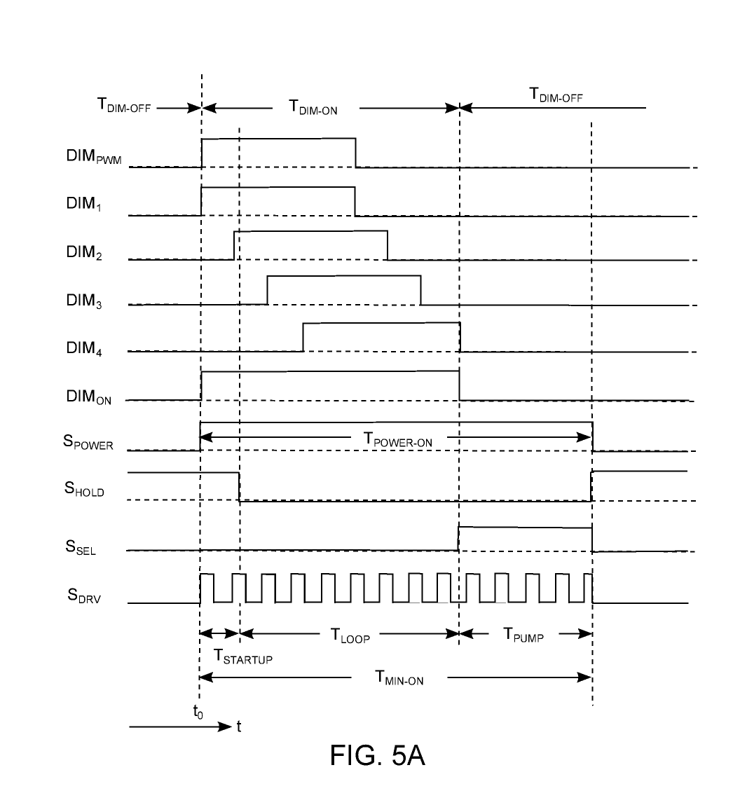

FIG. 4 details the backlight module 104 in FIG. 3 and has power controller 108 and current control unit 106.

As shown in FIG. 4, current control unit 106 has several delay units D to delay the digital dimming signal DIM_{PWM} and to provide channel-enabled signals DIM₁˜DIM₄. Channel-enabled signals DIM₁˜DIM₄ control gate controllers GC₁˜GC₄ respectively. As gate controllers GC₁˜GC₄ are all alike or the same, only gate controller GC₁ is detailed and the rest could be derived based on the teaching regarding to gate controller GC₁. Gate controller GC₁ includes an operational amplifier 130 and a multiplexer 132. Operational amplifier 130 and current driver CD₁ (of FIG. 3) together can determine the value of driving current ILED₁. If channel-enabled signal DIM₁ is “1” in logic, LED module LED₁ is expected to be turned ON, a predetermined voltage V_{SET} (0.2V for example) is selected by multiplexer 132 to forward to operational amplifier 130, and the product of driving current ILED₁ and the resistance of current-sense resistor RS₁ is about the predetermined voltage V_{SET}, so LED module LED₁ is turned ON to emit light. In case that channel-enabled signal DIM₁ is “0” in logic, multiplexer 132 passes 0V to operational amplifier 130, and driving current ILED₁ is about 0 A, so LED module LED₁ is turned OFF and does not emit light. Simply put, channel-enabled signal DIM₁ could determine whether LED module LED₁ is ON or enabled to emit light with a constant brightness.

An OR gate with four inputs connected to channel-enabled signals DIM₁˜DIM₄ outputs a dimming condition signal DIM_{ON}. It can be concluded that if anyone of LED modules LED₁˜LED₄ is expected to be turned ON the dimming condition signal DIM_{ON} will be “1” in logic, and if none is turned ON then the dimming condition signal DIM_{ON} will be “0” in logic.

Minimum selector 122 provides minimum feedback voltage VFB_{MIN} based on the minimum of feedback voltages VFB₁˜VFB₄ at pins FB₁˜FB₄ respectively. Minimum feedback voltage VFB_{MIN} could represent one of feedback voltages VFB₁˜VFB₄, and feedback voltage VFB₁ for example is a terminal voltage at one end of LED module LED₁.

Inside power controller 108, when power-ON signal S_{POWER} is “1” in logic, control signal S_{DRV} is released from being constantly “0”, and pulse width modulator (PWM) generator 140 generates pulses with modulated pulse widths to be control signal S_{DRV} at pin DRV. Each pulse width is determined based on the value of compensation voltage V_{COM} at the moment when the pulse is generated. Boost converter 12 converts electric power accordingly. When power-ON signal S_{POWER} is “0” in logic, control signal S_{DRV} is clamped to be at 0V, or “0” in logic, and boost converter 12 stops converting electric power. In other words, power-ON signal S_{POWER} presents whether boost converter 12 is allowed to convert power to power LED modules LED₁˜LED₄.

Power controller 108 also has an operational transcoductance amplifier (OTA) 142. Connected between OTA 142 and pin COM is a switch controlled by hold signal S_{HOLD}. Hold signal S_{HOLD}, if it is “0”, causes the switch a short circuit, so OTA 142 can charge/discharge compensation capacitor 23 to change compensation voltage V_{COM}. Nevertheless, if it is “1”, then the switch is an open circuit, output of OTA 142 is isolated from compensation capacitor 23, so compensation voltage V_{COM} is held as unchanged.

Selection signal S_{SEL} controls multiplexer 132 to pass either 0.2V or minimum feedback voltage VFB_{MIN} to an inverted input of OTA 142.

When selection signal S_{SEL}, hold signal S_{HOLD}, and power-ON signal S_{POWER} are “0”, “0”, and “1” respectively, the signal path passing through minimum feedback voltage VFB_{MIN}, to compensation voltage V_{COM}, control signal S_{DRV}, output voltage V_{OUT} and back to minimum feedback voltage VFB_{MIN} can form a close loop, based on which power controller 108 lets power converter 12 convert and provide electric power to LED modules LED₁˜LED₄, in order to regulate minimum feedback voltage to be about 0.4V. This close loop could be broken and becomes an open loop if selection signal S_{SEL} is “1”, hold signal S_{HOLD} “1” or power-ON signal S_{POWER} “0”.

State controller 160 determines the logic values of selection signal S_{SEL}, hold signal S_{HOLD}, and power-ON signal S_{POWER}, based on dimming condition signal DIM_{ON}. It is implied that state controller 160 determines whether the close loop forms or disappears.

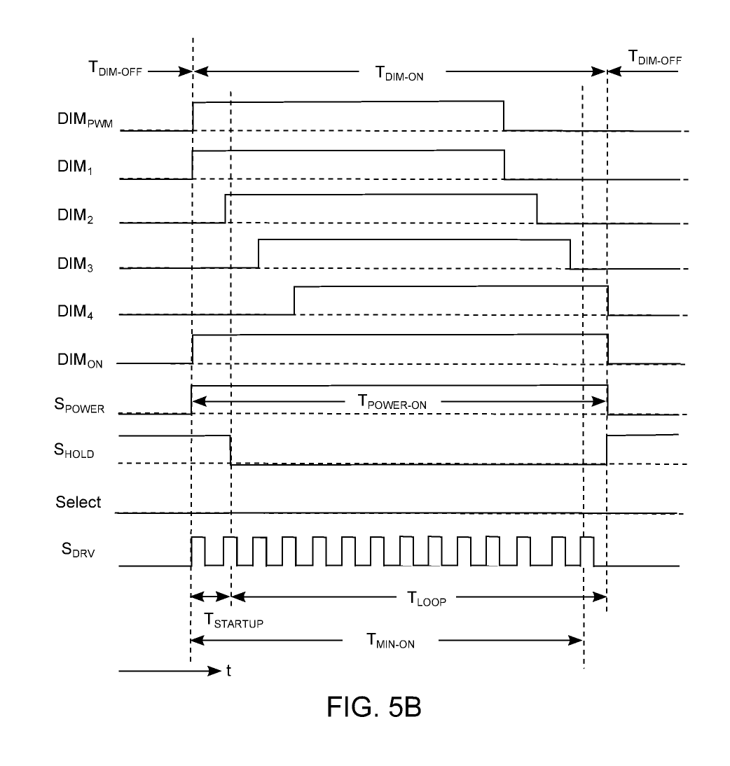

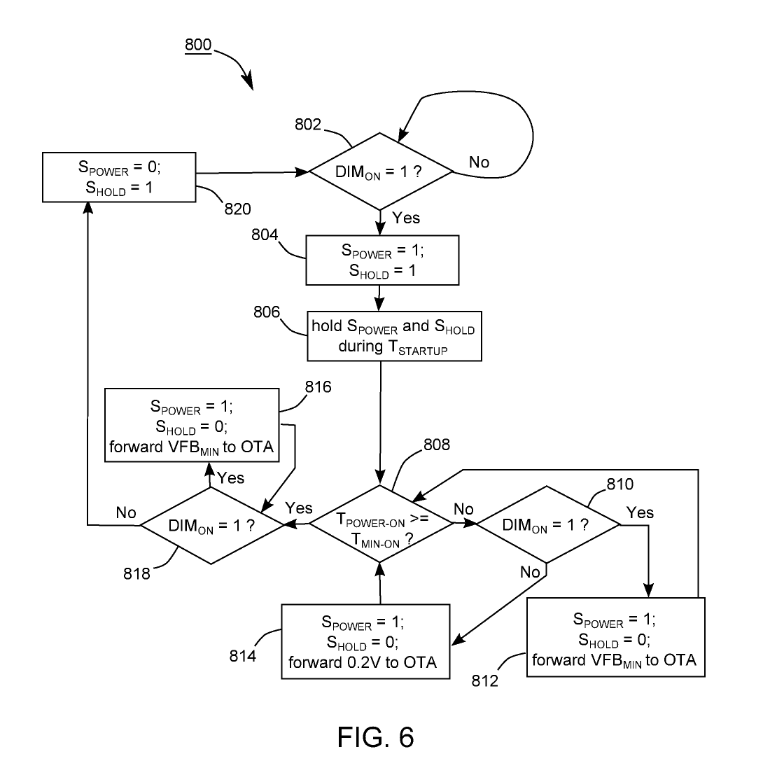

FIG. 5A shows some waveforms of signals in FIG. 4 when dimming-ON time T_{DIM-ON} is less than a predetermined minimum power-ON time T_{MIN-ON}. Waveforms shown in FIG. 5A are, from top to bottom, digital dimming signal DIM_{PWM}, channel-enabled signals DIM₁˜DIM₄, dimming condition signal DIM_{ON}, power-ON signal S_{POWER}, hold signal S_{HOLD}, selection signal S_{SEL} and control signal S_{DRV}.

Derivable from FIGS. 4 and 5A, channel-enabled signals DIM₁˜DIM₄ are generally equivalent to digital dimming signal DIM_{PWM}. They share substantially the same waveform but have different time delays. Dimming condition signal DIM_{ON} is the output result of an OR gate with inputs of channel-enabled signals DIM₁˜DIM₄, as shown in FIG. 5A. Dimming-ON time T_{DIM-ON} is the duration when dimming condition signal DIM_{ON} is “1”. As defined in advance, during dimming-ON time T_{DIM-ON}, at least one LED module is expected to be turned ON, emitting light. In the opposite, a dimming-OFF time T_{DIM-OFF} is a duration when dimming condition signal DIM_{ON} is “0”, or the duration when no LED module is turned ON to emit light. As a result, digital dimming signal DIM_{PWM} determines the waveform of dimming condition signal DIM_{ON}.

Demonstrated in FIG. 5A, in the beginning, digital dimming signal DIM_{PWM}, channel-enabled signals DIM₁˜DIM₄, dimming condition signal DIM_{ON}, power-ON signal S_{POWER}, selection signal S_{SEL}, and control signal S_{DRV} are all “0”, but hold signal S_{HOLD} is “1”. In the meantime, no LED module is driven or emits light, compensation voltage V_{COM} is held as unchanged, and boost converter 12 does not convert electric power.

At time point t₀, digital dimming signal DIM_{PWM} switches to be “1”, so dimming condition signal DIM_{ON} becomes “1” accordingly to announce the beginning of dimming-ON time T_{DIM-ON}. Shown in FIG. 5A, state controller 160 predetermines two periods of time, one is startup time T_{STARTUP} and the other minimum power-ON time T_{MIN-ON}, both starting from the beginning of the dimming-ON time T_{DIM-ON}. Nevertheless, minimum power-ON time T_{MIN-ON} ends later than startup time T_{STARTUP} does. In other words, minimum power-ON time T_{MIN-ON} is longer than startup time T_{STARTUP}.

During startup time T_{STARTUP}, power-ON signal S_{POWER}, hold signal S_{HOLD}, and selection signal S_{SEL} are “1”, “1” and “0” respectively. It implies that compensation voltage V_{COM} is held as unchanged, and boost converter 12 converts electric power to power LED modules LED₁˜LED₄ based on this held compensation voltage V_{COM}. Please note that the close loop for regulating minimum feedback voltage VFB_{MIN} does not form during startup time T_{STARTUP}. Introducing startup time T_{STARTUP} is beneficial in reducing the influence of unstable minimum feedback voltage VFB_{MIN} at the beginning of dimming-ON time T_{DIM-ON}. As illustrated in FIGS. 2A and 2B, at the beginning of dimming-ON time T_{DIM-ON}, minimum feedback voltage VFB_{MIN}, which stayed at a relatively high level in a previous dimming-OFF time T_{DIM-OFF}, drops abruptly. During startup time T_{STARTUP}, compensation voltage V_{COM} is held as unchanged so that the abrupt change of minimum feedback voltage VFB_{MIN} could not wrongly influence compensation voltage V_{COM}.

FIG. 5A defines close-loop time T_{LOOP} as the duration starting at the end of startup time T_{STARTUP} and ending at the end of dimming-ON time T_{DIM-ON}. During close-loop time T_{LOOP}, power-ON signal S_{POWER}, hold signal S_{HOLD}, and selection signal S_{SEL} are “1”, “0” and “0” respectively. Therefore, the signal path passing through minimum feedback voltage VFB_{MIN}, to compensation voltage V_{COM}, control signal S_{DRV}, output voltage V_{OUT} and back to minimum feedback voltage VFB_{MIN} forms a close loop, based on which power controller 108 lets power converter 12 convert and provide electric power to LED modules LED₁˜LED₄, in order to regulate minimum feedback voltage to be about 0.4V.

FIG. 5A also defines pump time T_{PUMP} as the duration starting at the end of dimming-ON time T_{DIM-ON} and ending at the end of minimum power-ON time T_{MIN-ON}. During pump time T_{PUMP}, power-ON signal S_{POWER}, hold signal S_{HOLD}, and selection signal S_{SEL} are “1”, “0” and “1” respectively. The close loop, which formed during close-loop time T_{LOOP}, is open now because selection signal S_{SEL} with logic value of “1” causes multiplexer 132 in FIG. 4 to forward 0.2V to OTA 142. A constant difference, equal to 0.4V minus 0.2V, between the inputs of OTA 142 is introduced in the meantime, so OTA 142 outputs a constant current and charges compensation capacitor 23, rising compensation voltage V_{COM}. Even though none of LED modules emit light during pump time T_{PUMP}, boost converter 12 continues converting power to build output voltage V_{OUT} according to the risen compensation voltage V_{COM}.

In FIG. 5A, when minimum power-ON time T_{MIN-ON} ends, power-ON signal S_{POWER}, hold signal S_{HOLD}, and selection signal S_{SEL} become “0”, “1” and “0” respectively, returning back to the original states before the beginning of dimming-ON time T_{DIM-ON}. A power-ON time T_{POWER-ON} is defined as the duration when power-ON signal S_{POWER} is “1”, or the duration when boost converter 12 is enabled to convert power. As shown in FIG. 5A, dimming-ON time T_{DIM-ON} is less than minimum power-ON time T_{MIN-ON}, so pump time T_{PUMP} follows dimming-ON time T_{DIM-ON}, and power-ON time T_{POWER-ON} is about equal to minimum power-ON time T_{MIN-ON}

FIG. 5B shows some waveforms of signals in FIG. 4 when dimming-ON time T_{DIM-ON} exceeds minimum power-ON time T_{MIN-ON}. The similarity between FIGS. 5A and 5B is understandable based on the previous teaching regarding to FIG. 5A, and is omitted hereinafter for brevity. Nevertheless, unlike FIG. 5A, which shows a much shorter dimming-ON time T_{DIM-ON}, FIG. 5B shows a dimming-ON time T_{DIM-ON} longer than minimum power-ON time T_{MIN-ON}. Accordingly, FIG. 5B does not show pump time T_{PUMP}, which as defined in FIG. 5A starts at the end of dimming-ON time T_{DIM-ON} and stops at the end of minimum power-ON time T_{MIN-ON}. In FIG. 5B, power-ON time T_{POWER-ON} is about equal to dimming-ON time T_{DIM-ON}.

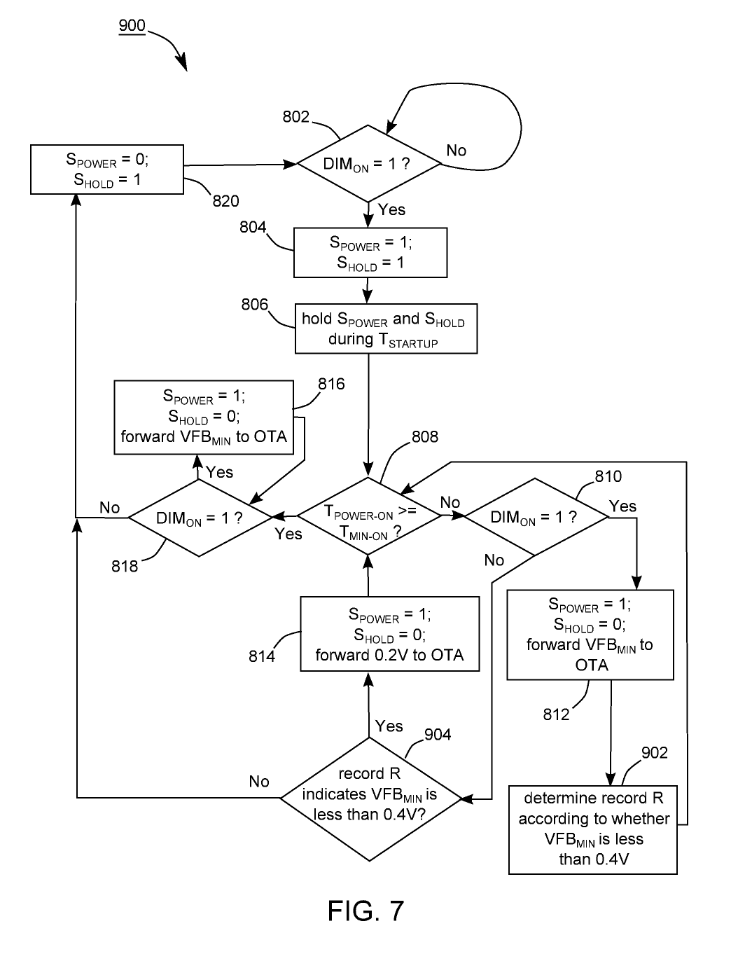

FIG. 6 shows a flow chart 800 for generating power-ON signal S_{POWER}, hold signal S_{HOLD}, and selection signal S_{SEL}, suitable for the use in state controller 160.

Step 802 checks whether digital dimming signal DIM_{ON} is “1”. If digital dimming signal DIM_{ON} is “0”, power-ON signal S_{POWER} and hold signal S_{HOLD} are held as “0” and “1” respectively, so boost converter 12 is not converting electric power and compensation voltage V_{COM} is held as unchanged. Otherwise, if digital dimming signal DIM_{ON} is “1”, steps 804 and 806 follow.

Step 804 set both power-ON signal S_{POWER} and hold signal S_{HOLD} to be “1”, meaning the beginning of power-ON time T_{POWER-ON} and the continuous hold of compensation voltage V_{COM}. Step 806 holds the logic values of power-ON signal S_{POWER}, hold signal S_{HOLD}, and selection signal S_{SEL} until the end of startup time T_{STARTUP}.

Step 808 follows step 806, checking whether power-ON time T_{POWER-ON} has exceeded minimum power-ON time T_{MIN-ON}. A negative result from step 808 makes step 810 follow, and step 810 checks if dimming condition signal DIM_{ON} is “1”. If power-ON time T_{POWER-ON} is less than minimum power-ON time T_{MIN-ON} and dimming condition signal DIM_{ON} is “1”, it means backlight module 100 should be operating in close-loop time T_{LOOP}, so step 812 follows to set power-ON signal S_{POWER}, hold signal S_{HOLD}, and selection signal S_{SEL} as “1”, “0”, and “0” respectively. In case that power-ON time T_{POWER-ON} is still less than minimum power-ON time T_{MIN-ON} but dimming condition signal DIM_{ON} has changed into “0”, then it means backlight module 100 should be operating in pump time T_{PUMP}, so in step 814 power-ON signal S_{POWER}, hold signal S_{HOLD}, and selection signal S_{SEL} are set to be “1”, “0”, and “1” respectively. Step 808 also follows steps 814 and 812, continuously checking if power-ON time T_{POWER-ON} has exceeded minimum power-ON time T_{MIN-ON}.

Once power-ON time T_{POWER-ON} exceeds minimum power-ON time T_{MIN-ON}, step 818 follows, checking if dimming condition signal DIM_{ON} is “1”. In the meantime, dimming condition signal DIM_{ON} with a logic value of “1” means backlight module 100 should be operating in close-loop time T_{LOOP}, so step 816, which is the same with step 812, follows to set power-ON signal S_{POWER}, hold signal S_{HOLD}, and selection signal S_{SEL} as “1”, “0”, and “0” respectively. If dimming condition signal DIM_{ON} changes to be “0” after power-ON time T_{POWER-ON} has exceeded minimum power-ON time T_{MIN-ON}, step 820 follows to set power-ON signal S_{POWER} “0” and hold signal S_{HOLD} “1”, resetting these signals back to what they were before the beginning of dimming-ON time T_{DIM-ON}. Step 802 follows step 820.

Based on the teaching of FIG. 6, it is concluded that the operation during startup time T_{STARTUP} is performed by steps 804 and 806, the operation during pump time T_{PUMP} is performed by step 814, and the operation during close-loop time T_{LOOP} is performed by steps 816 and 812.

Derivable from FIGS. 5A and 5B, power-ON time T_{POWER-ON} is at least equal to minimum power-ON time T_{MIN-ON}. If dimming-ON time T_{DIM-ON} is so short, then state controller 104 automatically adds pump time T_{PUMP} after startup time T_{STARTUP} and close-loop time T_{LOOP}, to expand power-ON time T_{POWER-ON} and make it equal to minimum power-ON time T_{MIN-ON}, as shown in FIG. 5A. If dimming-ON time T_{DIM-ON} is long enough to has power-ON time T_{POWER-ON} longer than minimum power-ON time T_{MIN-ON},then pump time T_{PUMP} is unnecessary, disappearing as demonstrated in FIG. 5B.

The insertion of pump time T_{PUMP} could avoid flickering caused by a too-short dimming-ON time T_{DIM-ON}. During pump time T_{PUMP}, power converter 102 lacks the information of minimum feedback voltage VFB_{MIN}, and blindly converts excess electric power, even though LED modules are not emitting light. The excess electric power will be accumulated in the output node of power converter 102, so LED modules LED₁˜LED4 could have enough electric power to properly emit light in subsequent dimming-ON times T_{DIM-ON}.

Unfortunately, the excess electric power might cause output voltage V_{OUT} over high and damage to current driver CD₁˜CD₄. In one embodiment of the invention, power controller 108 in FIG. 3 detects output voltage V_{OUT} via voltage-dividing resistors 101 and 103. If output voltage V_{OUT} is found to be over high, exceeding a predetermined value, then an over-voltage protection is triggered, so power controller 108 forces power-ON signal S_{POWER} to be “0” and power conversion by power converter 102 stops. Meanwhile, current control unit 106 is still allowed to control driving currents ILED₁˜ILED₄ in response to digital dimming signal DIM_{PWM}. For example, if over-voltage protection is triggered, then pump time T_{PUMP} is forbidden to be added even if dimming-ON time T_{DIM-ON} is very short. Adding of pump time T_{PUMP} could be resumed when over-voltage protection is released or output voltage V_{OUT} has dropped down to a certain safe level.

In FIG. 4, the logic value of selection signal S_{SEL} has no impact to compensation voltage V_{OUT} when hold voltage S_{HOLD} is “1”, because OTA 142 is isolated from compensation capacitor 23. For instance, during startup time T_{STARTUP} in FIG. 5A or 5B, selection signal S_{SEL} is not limited to be “0”, and could be “1” instead.

In another embodiment of the invention, during minimum power-ON time T_{MIN-ON}, the non-inverted input of OTA 142 in FIG. 4 receives 0.8V rather than 0.4V. Accordingly, close-loop time T_{LOOP}, if long enough, could consist of two portions, separated by the end of minimum power-ON time T_{MIN-ON}. During the front portion, the close loop regulates minimum feedback voltage VFB_{MIN} to be 0.8V, and during the rear portion, the same close loop regulates it to be 0.4V.

Some embodiments of the invention might not limit power-ON time T_{POWER-ON} to be not less than minimum power-ON time T_{MIN-ON} all the time. For example, under some predetermined conditions, pump time T_{PUMP} might not appear even though dimming-ON time T_{DIM-ON} is shorter than minimum power-ON time T_{MIN-ON}.

FIG. 7 shows another flowchart 900 for generating power-ON signal S_{POWER}, hold signal S_{HOLD}, and selection signal S_{SEL}, also suitable for the use in state controller 160 of FIG. 4. Comparing with the flow chart in FIG. 6, flow chart 900 further has steps 902 and 904, where step 902 follows step 812 and step 904 follows a negative result of step 810. Both steps 902 and 904 are performed during close-loop time T_{LOOP}. Step 902 checks whether minimum feedback voltage VFB_{MIN} is below 0.4V and make a record R accordingly. For example, record R is “1” if minimum feedback voltage VFB_{MIN} exceeds 0.4V, and is “0” otherwise. The record R with “1” implies that output voltage V_{OUT} is high enough to drive LED modules LED₁˜LED₄ in a proper manner. In the opposite, the record R with “0” could indicate that output voltage V_{OUT} is too low to drive LED modules LED₁˜LED₄ properly.

Step 904 follows step 810, determining whether pump time T_{PUMP} is going to appear. If the record R decided in step 902 shows that minimum feedback voltage VFB_{MIN} is below 0.4V, then step 814 follows step 904 to elongate power-ON time T_{POWER-ON}, so pump time T_{PUMP} appears to boost output voltage V_{OUT}. Otherwise, if the record R decided in step 902 indicates that minimum feedback voltage VFB_{MIN} is above 0.4V, then step 820 follows step 904 to immediately terminate power-ON time T_{POWER-ON}, and pump time T_{PUMP} is skipped. Obviously, if the flow goes from step 904 to step 820, power-ON time T_{POWER-ON} is shorter than minimum power-ON time T_{MIN-ON}. In other words, flow chart 900 allows power-ON time T_{POWER-ON} to be less than minimum power-ON time T_{MIN-ON}.

Flow chart 900 in FIG. 7 teaches that a detection result, the record R, made during close-loop time T_{LOOP} is employed later to decide whether pump time T_{PUMP} is added. In comparison with flow chart 800 in FIG. 6, flow chart 900 could have high conversion efficiency and avoid the event of over high output voltage V_{OUT}.

Beside minimum feedback voltage VFB_{MIN}, there are other signals capable of indicating whether output voltage V_{OUT} is high enough to drive LED modules LED₁˜LED₄ properly. For instance, during close-loop time T_{LOOP}, if any of the voltages at pin GAT₁˜GAT₄ (of FIG. 3) exceeds a predetermined safe level, then output voltage V_{OUT} could be deemed too low to drive LED modules LED₁˜LED₄. The voltages at pin GAT₁˜GAT₄ are the gate voltages of the NMOS transistors in current drivers CD₁˜CD₄, where each of the NMOS transistors is a voltage-controllable current source.

While the invention has been described by way of example and in terms of preferred embodiment, it is to be understood that the invention is not limited thereto. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A control method for light dimming, comprising:
providing a dimming condition signal, wherein a first logic value of the dimming condition signal represents a light emitting device is expected to be emitting light, and a second logic value of the dimming condition signal represents the light emitting device is expected not to be emitting light, wherein the duration when the dimming condition signal is at the first logic value is a dimming-ON time;
providing, in the dimming-ON time, a close loop to make a power converter convert electric energy to the light emitting device such that the light emitting device is capable of emitting light, wherein a power-ON time is the duration when the power converter converts electric energy to the light emitting device; and
continuing, when the dimming condition signal is switched to be at the second logic value and the dimming-ON time is less than a minimum power-ON time, the power converter converting the electric energy to the light emitting device so as to keep the power-ON time not less than the minimum power-ON time.

2. The control method of claim 1, wherein the step of continuing comprises:
making the close loop open; and
providing a constant current to charge/discharge a compensation capacitor such that a compensation voltage at the compensation capacitor is changed;
wherein the power converter provides electric energy to the light emitting device based on the compensation voltage.

3. The control method of claim 1, further comprising:
making, when the dimming condition signal is switched to be at the second logic value and the dimming-ON time exceeds the minimum power-ON time, the close loop open, and stopping providing electric energy to the light emitting device.

4. The control method of claim 1, further comprising:
receiving a digital dimming signal;
in response to the digital dimming signal, generating channel-enabled signals to control light emitting devices respectively; and
providing the dimming condition signal in response to the channel-enabled signals.

5. The control method of claim 4, comprising:
delaying the digital dimming signal to generate one of the channel-enabled signals.

6. The control method of claim 1, comprising:
making, during a startup time after a beginning of the dimming-ON time, the close loop open, and making the power converter convert electric energy to the light emitting device;
wherein the startup time is shorter than the minimum power-ON time.

7. The control method of claim 6, wherein during the startup time, a compensation voltage at a compensation capacitor is held as unchanged.

8. The control method of claim 1, comprising:
detecting, in the dimming-ON time, a driving signal driving the light emitting device to generate a record;
continuing, when the dimming condition signal is switched to be at the second logic value, the dimming-ON time is less than a minimum power-ON time, and the record is a first value, converting the electric energy to the light emitting device for keeping the power-ON time not less than the minimum power-ON time; and
stopping, when the dimming condition signal is switched to be at the second logic value, the dimming-ON time is less than a minimum power-ON time, and the record is a second value different with the first value, converting the electric energy to the light emitting device.

9. The control method of claim 1, wherein the driving signal is a driving voltage at an end terminal of the light emitting device.

10. The control method of claim 1, wherein the driving signal is a control voltage at a control terminal of a voltage-controllable current source.

11. The control method of claim 1, further comprising:
detecting an output voltage of the power converter; and
stopping, when the output voltage exceeds a predetermined value, the power converter converting the electric energy to the light emitting device.

12. The control method of claim 1, wherein the light emitting device comprises a light emitting diode.

13. The control method of claim 1, wherein the duration when the close loop is provided is a close-loop time, the duration when the dimming condition signal is at the second logic value and the power converter continues converting the electric energy to the light emitting device is a pump time, and the pump time continuously follows the close-loop time.

14. A back-light controller, comprising:
a current control unit, receiving a digital dimming signal to generate a dimming condition signal and to control a driving current through a light emitting device, wherein, when the dimming condition signal is at a first logic value the driving current is about 0, and when the diming condition signal is at a second logic value different from the first logic value the driving current is about a constant more than 0, wherein the duration when the dimming condition signal is at the first logic value is a dimming-ON time; and
a power controller for controlling a power converter to convert electric power to the light emitting device, wherein the duration when the power converter converts the electric energy to the light emitting device is a power-ON time;
wherein, when the dimming condition signal is at the first logic value, the power controller provides a close loop and the power converter converts, based on the close loop, the electric energy to the light emitting device such that the light emitting device is capable of emitting light; and
when the dimming condition signal is switched to be at the second logic value and the dimming-ON time is less than a minimum power-ON time, the power converter continues converting the electric energy to the light emitting device for elongating the power-ON time to be not less than the minimum power-ON time.

15. The backlight controller of claim 14, wherein the duration when the close loop is provided is a close-loop time, the duration when the dimming condition signal is at the second logic value and the power converter continues providing the electric energy to the light emitting device is a pump time, and the pump time follows the close-loop time.

16. The backlight controller of claim 15, wherein during the pump time, the current control unit provides a constant current to charge/discharge a compensation capacitor such that electric power delivered from the power converter to the light emitting device increases.

17. The backlight controller of claim 15, wherein
during the close-loop time, based on a driving signal to the light emitting device, the power controller generates a record;
when the dimming condition signal is switched to be at the second logic value, the dimming-ON time is less than a minimum power-ON time, and the record is a first value, the pump time follows the close-loop time; and
when the dimming condition signal is switched to be at the second logic value, the dimming-ON time is less than a minimum power-ON time, and the record is a second value, the power converter is stopped from converting the electric energy to the light emitting device.
